(19) United States
(12) Patent Application Publication
(10) Pub. No.: US 2025/0329783 A1
(43) Pub. Date: Oct. 23, 2025

(54) ELECTROLYTE SOLUTION FOR LITHIUM SECONDARY BATTERY AND LITHIUM SECONDARY BATTERY INCLUDING THE SAME

(71) Applicants: Hyundai Motor Company, Seoul (KR); Kia Corporation, Seoul (KR); Korea Advanced Institute of Science and Technology, Daejeon (KR)

(72) Inventors: Eunji Kwon, Hwaseong (KR); Ji Yong Lee, Hwaseong (KR); WonKeun Kim, Hwaseong (KR); Samuel Seo, Hwaseong (KR); Yeonjong Oh, Hwaseong (KR); Kyuju Kwak, Hwaseong (KR); Dong Hyun Lee, Hwaseong (KR); Sangsu Lee, Hwaseong (KR); Kyoung Han Ryu, Hwaseong (KR); Jiho Lim, Hwaseong (KR); Nam-Soon Choi, Daejeon (KR); Jeong-A Lee, Daejeon (KR); Haneul Kang, Daejeon (KR)

(21) Appl. No.: 18/949,104

(22) Filed: Nov. 15, 2024

(30) Foreign Application Priority Data
Apr. 18, 2024 (KR) 10-2024-0051842

(51) Int. Cl. H01M 10/0567; H01M 4/66; H01M 10/052; H01M 10/0568; H01M 10/0569

(52) U.S. Cl. CPC H01M 10/0567; H01M 4/661; H01M 10/052; H01M 10/0568; H01M 10/0569; H01M 2300/0028

(57) ABSTRACT

An electrolyte solution for a lithium secondary battery is provided, comprising a lithium salt, a nonaqueous organic solvent with at least 50% FSA by volume, and a silver (Ag) compound additive selected from AgHFB, AgPFP, or silver trifluoroacetate. The additive is present in an amount of about 0.05 wt % to 0.2 wt % to promote stable SEI layer formation and reduce lithium deposition overvoltage. The solution may also include a secondary additive such as calcium hydride (CaH₂) or magnesium fluoride (MgF₂) to further suppress lithium dendrite growth. The lithium secondary battery incorporating this electrolyte is designed to form a lithium metal layer with a thickness of 40 to 45 μm and a surface pore average diameter of less than 1 μm during the initial charging process, optimizing performance and stability.

### CROSS-REFERENCE TO RELATED APPLICATION

This application claims under 35 U.S.C. § 119 (a) the benefit of Korean Patent Application No. 10-2024-0051842 filed in the Korean Intellectual Property Office on Apr. 18, 2024, the entire contents of which are incorporated herein by reference.

### BACKGROUND

### Technical Field

The present disclosure relates to electrolyte solutions for lithium secondary batteries, and more specifically, to an electrolyte solution that includes a silver (Ag) compound additive, a nonaqueous organic solvent, and a lithium salt, which together enhance the formation of a stable solid electrolyte interphase (SEI) layer, improve lithium ion reversibility, and reduce lithium deposition overvoltage. The disclosure also pertains to lithium secondary batteries incorporating this electrolyte solution, which are designed to optimize electrochemical performance, stability, and safety.

### Background

Due to the growth of the electric vehicle market, there is an increasing need for high-capacity batteries that surpass lithium ion batteries, leading to growing demands for negative and positive electrode materials with high energy density, as well as for high energy density and long-term stability in lithium metal batteries.

Among them, a negative electrode-free battery (Cu|NCM811) and a lithium metal battery (Li|NCM811) have a merit of higher energy density per volume than a conventional lithium ion battery, but due to the instability of an interface between a Cu current collector and a lithium metal, they have rapid capacity degradation and low lifetime performance, and have a big problem with commercialization.

In particular, a pristine-Cu current collector which is not surface-treated does not undergo Li+ electrodeposition and causes overvoltage. In addition, in lithium metal batteries, the formation of an unstable solid electrolyte interphase (SEI) layer due to the high reactivity of lithium accelerates side reactions between the electrolyte solution and the lithium metal, leading to battery deterioration.

Therefore, it is necessary to address and solve the aforementioned problems.

### SUMMARY OF THE DISCLOSURE

The present disclosure attempts to provide an electrolyte solution capable of improving reversibility of a lithium ion and surface stabilization of a current collector and a lithium metal by forming an Ag-based coating on a surface of the current collector and/or the lithium metal.

The present disclosure also attempts to provide an electrolyte solution capable of implementing excellent lifespan performance even under evaluation conditions of a high positive electrode specific capacity and injection of a small amount of the electrolyte solution, and a lithium secondary battery including the electrolyte solution.

In some embodiments, an electrolyte solution for a lithium secondary battery comprises a lithium salt, a nonaqueous organic solvent, and a silver (Ag) compound additive. The silver (Ag) compound additive may include one or more selected from AgHFB, AgPFP, or silver trifluoroacetate.

As referred to herein, the term “solution” or “electrolyte solution” includes a variety of fluid admixtures including dispersions and traditional or true solutions. As used herein, unless indicated otherwise, the term “solution” including “electrolyte solution” is the same as “composition” or “electrolyte composition” or “electrolyte admixture”.

The electrolyte solution may include about 0.05 wt % to 0.2 wt % of the silver (Ag) compound additive based on the total weight of the electrolyte solution. Alternatively, the solution may contain about 0.01 wt % to 0.09 wt % of the silver (Ag) compound additive. The nonaqueous organic solvent in the solution may comprise fluorosulfonamide (FSA).

The lithium salt in the electrolyte solution may include one or more of the following: LiFSI, LiPF₆, LiClO₄, LiBF₄, LiTFSI, LiSO₃CF₃, LiBOB, LiFOB, LiDFBP, LiTFOP, LiPO₂F₂, LiCl, LiBr, LiI, LiB₁₀Cl₁₀, LiCF₃SO₃, LiCF₃CO₂, LiAsF₆, LiSbF₆, LiAlCl₄, CH₃SO₃Li, CF₃SO₃Li, LiSCN, or LiC(CF₃SO₂)₃. The lithium salt may have a molar concentration of about 2.5 to 3.5 M.

In some embodiments, a lithium secondary battery includes a positive electrode, a negative electrode current collector opposite to the positive electrode, a separator interposed between the positive electrode and the negative electrode current collector, and the electrolyte solution as described above.

The negative electrode current collector may comprise a lithium metal layer formed on it, and this lithium metal layer may be formed during the formation charging and discharging process of the lithium secondary battery. The battery may have a formation charge and discharge current density of about 0.2 mA·cm−2. The lithium metal layer may be formed to a thickness of about 40 to 45 μm and may have a surface pore average diameter of less than about 1 μm. The battery may further include an Ag-based intermediate layer disposed between the negative electrode current collector and the lithium metal layer.

The positive electrode in the lithium secondary battery may comprise a positive electrode active material layer containing a lithium-nickel-manganese-cobalt-based metal oxide.

In some embodiments, an electrolyte solution for a lithium secondary battery includes a lithium salt, a nonaqueous organic solvent comprising at least 50% by volume of FSA, and a silver (Ag) compound additive. The silver (Ag) compound additive may include one or more selected from AgHFB, AgPFP, or silver trifluoroacetate and may be present in an amount of about 0.05 wt % to 0.1 wt % based on the total weight of the electrolyte solution to promote the formation of a stable SEI layer and reduce lithium deposition overvoltage.

The lithium salt in the solution may comprise LiFSI, with a concentration specifically between 2.9 M and 3.1 M to optimize ionic conductivity and electrochemical performance. The silver (Ag) compound additive may form an Ag-based coating on the surface of the negative electrode current collector during the initial charging process, improving the reversibility of lithium ions and enhancing surface stabilization.

The electrolyte solution may further include a secondary additive selected from calcium hydride (CaH2) or magnesium fluoride (MgF2) in an amount of about 0.5 wt % to 2.0 wt % to suppress lithium dendrite growth and enhance electrolyte stability. The nonaqueous organic solvent may be selected to maximize the solubility of the silver (Ag) compound additive, facilitating uniform SEI layer formation.

The electrolyte solution may comprise about 0.1 wt % to 0.2 wt % of the silver (Ag) compound additive. A lithium secondary battery may include the electrolyte solution as described above, a positive electrode, a negative electrode current collector, and a separator, where the negative electrode current collector is configured to form a lithium metal layer with a thickness of 40 to 45 μm during the initial charging process, and the lithium metal layer has a surface pore average diameter of less than 1 μm.

An electrolyte solution (electrolyte composition) as disclosed herein preferably has minimal water content, i.e. an electrolyte solution (electrolyte composition) is substantially nonaqueous. For example, preferably an electrolyte solution (electrolyte composition) has less than 8, 7, 6, 5, 4, 3, 2, 1, 0.5, 0.25 or 0. ′15 weight percent water based on total weight of the electrolyte solution (electrolyte composition).

As discussed, the method and system suitably include use of a controller or processer.

In another embodiment, vehicles are provided that comprise an apparatus as disclosed herein.

### BRIEF DESCRIPTION OF THE DRAWINGS

FIGS. 1A to 1E and FIG. 2 show results of XPS analysis of a negative electrode current collector interface, after charging and discharging a Cu/NCM811 negative electrode-free battery using the electrolyte solutions according to Example 1 and Comparative Example 1.

FIGS. 3A to 3E and FIG. 4 show results of XPS analysis of a negative electrode current collector interface, after charging and discharging a Li/NCM811 negative electrode-free battery using the electrolyte solutions according to Example 1 and Comparative Example 1.

FIGS. 5A to 5C are digital photo images of electrodeposited lithium of batteries using the electrolyte solutions of Example 1 and Comparative Example 1.

FIGS. 6A and 6B show surface SEM analysis results of electrodeposited lithium of batteries using the electrolyte solutions of Example 1 and Comparative Example 1.

FIG. 7 shows results of electrodeposited lithium cross-sectional SEM analysis of batteries using the electrolyte solutions of Example 1 and Comparative Example 1.

FIG. 8 shows results of initial efficiency evaluation of batteries using the electrolyte solutions of Example 1 and Comparative Example 1.

FIGS. 9A to 9C show results of lifespan evaluation of Cu/NCM811 negative electrode-free batteries using the electrolyte solutions of Example 1 and Comparative Example 1.

FIG. 10 shows results of lifespan evaluation of Li/NCM811 batteries using the electrolyte solutions of Example 1 and Comparative Example 1.

FIG. 11A is a charge graph at a 192^{nd} cycle of a Li/NCM811 battery using the electrolyte solution of Comparative Example 1. FIG. 11B is a charge and discharge graph at a 192^{nd} cycle of a Li/NCM811 battery using the electrolyte solution of Example 1.

FIGS. 12A to 12C shows results of lifespan evaluation of Cu/NCM811 negative electrode-free batteries using the electrolyte solutions of Examples 1 and 2 and Comparative Examples 1 and 2.

### DETAILED DESCRIPTION OF THE EMBODIMENTS

The terms such as first, second, and third in the present specification are used for describing various parts, components, areas, layers, and/or sections, but are not limited thereto. These terms are used only for distinguishing one part, component, area, layer, or section from other parts, components, areas, layers, or sections. Therefore, a first part, component, area, layer, or section described below may be mentioned as a second part, component, area, layer, or section without departing from the scope of the present disclosure.

The terminology used herein is only for mentioning a certain example, and is not intended to limit the present disclosure. Singular forms used herein also include plural forms unless otherwise stated clearly to the contrary. The meaning of “comprising” used in the specification is embodying certain characteristics, areas, integers, steps, operations, elements, and/or components, but is not excluding the presence or addition of other characteristics, areas, integers, steps, operations, elements, and/or components.

When it is mentioned that a part is “on” or “above” the other part, it means that the part is directly on or above the other part or another part may be interposed therebetween. In contrast, when it is mentioned that a part is “directly on” the other part, it means that nothing is interposed therebetween.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Though not defined otherwise, all terms including technical terms and scientific terms used herein have the same meaning as commonly understood by a person with ordinary skill in the art to which the present disclosure pertains. Terms defined in commonly used dictionaries are further interpreted as having a meaning consistent with the related technical literatures and the currently disclosed description, and unless otherwise defined, they are not interpreted as having an ideal or very formal meaning.

In the present specification, the term “combination(s) thereof” described in the Markush format refers to a mixture or combination of one or more selected from the group consisting of the constituent elements described in the Markush format, and refers to inclusion of one or more selected from the group consisting of the constituent elements.

Hereinafter, an example embodiment of the present disclosure will be described in detail so that a person with ordinary skill in the art to which the present disclosure pertains may easily carry out the disclosure. As those skilled in the art would realize, the described embodiments may be modified in various different ways, all without departing from the spirit or scope of the present disclosure.

### Electrolyte Solution for Lithium Secondary Battery

The electrolyte solution for a lithium secondary battery according to an example embodiment of the present disclosure may include: a lithium salt; a nonaqueous organic solvent; and silver (Ag) compound additive.

The silver (Ag) compound additive may include one or more selected from silver heptafluorobutyrate (AgHFB), silver pentafluoropropionate (AgPFP), or silver trifluoroacetate (Sigma-Aldrich), and specifically, may include AgHFB.

The silver (Ag) compound additive is an additive based on a silver cation, and forms an Ag-based coating on a surface of a negative electrode current collector and/or a lithium metal, thereby improving reversibility of a lithium ion and surface stabilization of current collector/lithium metal.

In addition, the silver (Ag) compound additive effectively suppresses decomposition of a lithium salt included in the electrolyte solution, thereby preventing change in solvation structure and lower concentration of the electrolyte solution due to occurrence of consumption of anions in a primary solvation structure of the electrolyte solution, which is thus preferred.

In the present disclosure, the electrolyte solution for a lithium secondary battery may include 0.05 to 0.2 wt %, specifically 0.05 to 0.1 wt %, 0.01 to 0.09 wt %, 0.02 to 0.08 wt %, 0.03to 0.07 wt %, or 0.04 to 0.06 wt % of the silver (Ag) compound additive, based on the total weight of the electrolyte solution.

When the silver (Ag) compound additive is included in the above range of wt %, an Ag-based coating may be formed on the surface of a current collector and a lithium metal, a lithium electrodeposition overvoltage may be greatly decreased, lithium may be uniformly electrodeposited without formation of voids, a side reaction between electrodeposited lithium and the electrolyte solution may be suppressed, and a lithium layer at a desired thickness may be electrodeposited. As a result, the life characteristics of a lithium secondary battery to which the electrolyte solution is applied may be improved, which is thus preferred.

The organic solvent may include fluorosulfonamide (FSA). In some embodiments, the FSA may be dimethyl sulfamoyl fluoride.

In the present disclosure, the nonaqueous organic solvent is used, thereby effectively dissolving the silver (Ag) compound additive and maximizing the effect of the silver (Ag) compound additive, which is thus preferred.

The lithium salt according to an example embodiment of the present disclosure may include one or more selected from LiFSI, LiPF₆, LiClO₄, LiBF₄, LiTFSI, LiSO₃CF₃, LiBOB, LiFOB, LiDFBP, LiTFOP, LiPO₂F₂, LiCl, LiBr, LiI, LiB₁₀Cl₁₀, LiCF₃SO₃, LiCF₃CO₂, LiAsF₆, LiSbF₆, LiAlCl₄, CH₃SO₃Li, CF₃SO₃Li, LiSCN, or LiC(CF₃SO₂)₃, and more specifically, may be LiFSI.

A concentration of the lithium salt included in the electrolyte solution for a lithium secondary battery according to an example embodiment of the present disclosure may be 2.0to 4.0 M, specifically 2.5 to 3.5 M, 2.6 to 3.4 M, 2.7 to 3.3 M, 2.8 to 3.2 M, or 2.9 to 3.1 M.

When the concentration of the lithium salt is below the range, the conductivity of the electrolyte solution may be lowered to deteriorate electrolyte solution performance, and when the concentration of the lithium salt exceeds the range, viscosity of the electrolyte solution is increased to decrease mobility of a lithium ion and overvoltage is applied from the beginning of the cycle. In addition, an Ag-based SEI layer which is formed on the surface of the negative electrode current collector or the negative electrode may not be formed, or a thick coating may be formed to deteriorate the electrochemical performance of the lithium secondary battery, which is thus not preferred.

The electrolyte solution for a lithium secondary battery according to the present disclosure may form an Ag-based coating on a negative electrode to improve cycle performance of the lithium secondary battery.

### Lithium Secondary Battery

Another example embodiment of the present disclosure provides a lithium secondary battery including the electrolyte solution for a lithium secondary battery. The lithium secondary battery including the electrolyte solution for a lithium secondary battery may be a negative electrode-free lithium secondary battery.

Specifically, the lithium secondary battery may include a positive electrode, a current collector opposite to the positive electrode, a separator interposed between the positive electrode and the negative electrode current collector, and the electrolyte solution for a lithium secondary battery.

The negative electrode current collector for a lithium secondary battery may be used as the negative electrode for a battery by itself.

The negative electrode or the negative electrode current collector for a battery does not include a lithium insert material or a lithium metal, and may be assembled into an electrode assembly and a battery with the positive electrode, the separator, and the like. As described later, in the battery including the negative electrode for a battery or the negative electrode current collector for a battery, lithium ions may move to the negative electrode for a battery or the negative electrode current collector for a negative electrode-free battery during charging to form a lithium metal layer. The battery may be charged and discharged by the formation or the removal of the lithium metal layer.

The lithium metal layer may be formed on the negative electrode current collector by formation charging and discharging.

The lithium secondary battery may have a formation charging and discharging current density of 0.2 mA·cm⁻².

The lithium metal layer may be formed to a thickness of 40 to 45 μm, and the lithium metal layer may have a surface pore average diameter of less than 1 μm.

The pore average diameter may be an average value of 3 to 10 pores diameters consecutively positioned which are confirmed in a SEM image. Meanwhile, a pore diameter may be an average value of a longest diameter and a longest diameter perpendicular to the longest diameter in a cross section of pores confirmed in the SEM image.

When the lithium metal layer satisfies the thickness and the porosity, a side reaction between the lithium metal layer and the electrolyte solution may be suppressed to improve electrochemical performance of the lithium secondary battery.

Meanwhile, an Ag-based intermediate layer disposed between the negative electrode current collector and the lithium metal layer may be included. The Ag-based intermediate layer may be formed by formation charging and discharging of the lithium secondary battery.

The intermediate layer may have a thickness of 100 nm to 10 μm, and specifically, 500 nm to 3 μm or 500 nm to 2 μm.

It is preferred to form the intermediate layer, since the lithium metal layer to be desired in the present disclosure may be effectively formed.

In another example embodiment, the positive electrode is disposed to opposite the negative electrode current collector for a battery.

The positive electrode may include a positive electrode current collector and a positive electrode active material layer formed on the positive electrode current collector.

The positive electrode current collector may be made of stainless steel, aluminum, nickel, titanium, calcined carbon, aluminum or stainless steel which is surface treated with carbon, nickel, titanium, silver, and the like, or the like.

The positive electrode current collector may have a thickness of 3 μm to 500 μm.

The positive electrode active material layer includes a positive electrode active material.

The positive electrode active material is a compound capable of reversible intercalation and deintercalation of lithium, and specifically, may include a lithium metal oxide including one or more selected from cobalt, manganese, nickel, or aluminum. More specifically, the lithium metal oxide may include one or more selected from lithium-manganese-based oxides, lithium-cobalt-based oxides, lithium-nickel-based oxides, lithium-nickel-manganese-based oxides, lithium-nickel-cobalt-based oxides, lithium-manganese-cobalt-based oxides, lithium-nickel-manganese-cobalt-based oxides, or lithium-nickel-cobalt-transition metal (M) oxides.

The positive electrode active material may be a lithium-nickel-manganese-cobalt-based oxide which may increase capacity characteristics and stability of a battery, and more specifically, may be Li(Ni_{0.6}Mn_{0.2}Co_{0.2})O₂, Li(Ni_{0.5}Mn_{0.3}Co_{0.2})O₂, or Li(Ni_{0.8}Mn_{0.1}Co_{0.1})O₂.

The positive electrode active material layer may further include a binder and/or a conductive material.

The separator separates a negative electrode and a positive electrode and provides a movement channel of lithium ions, and is not particularly limited as long as it is used as a separator in a common lithium secondary battery.

The following examples illustrate the present disclosure in more detail. However, the following examples are only a preferred example of the present disclosure, and the present disclosure is not limited by the following examples.

### EXAMPLES

### Preparation of Electrolyte Solution for Lithium Secondary Battery

A LiFSI salt was added at a concentration of 3.0 M to an FSA solvent and dissociated to form a solution, 1% or more of calcium hydride (CaH₂) of the solution weight was added, stirring was performed for 30 minutes, and solid-liquid separation was performed to obtain a solution with moisture removed. Next, an AgHFB additive was mixed to finally prepare an electrolyte solution for a lithium secondary battery.

Herein, the AgHFB additive was mixed so that it was 0.05 wt % based on the total weight of the electrolyte solution.

The following Table 1 shows compositions of the electrolyte solutions for a lithium secondary battery according to the examples and the comparative examples.

TABLE 1

| | LiFSI concentration | FSA | AgHFB |
|---|---|---|---|
| | (M) | (volume %) | (wt %) |
| Example 1 | 3 | 100 | 0.05 |
| Example 2 | 3 | 100 | 0.1 |
| Comparative Example 1 | 3 | 100 | — |
| Comparative Example 2 | 3 | 100 | 0.5 |

### Evaluation Example 1: XPS Analysis

### Evaluation Example 1-1: Evaluation of Cu/NCM811 Negative Electrode-Free Cell Electrode Interface

Cell type: Cu/W-scope separator (16 pi)/NCM811 positive electrode, 1.5T spacer, coin type cell 2032

Amount of electrolyte solution injected: 15 μl

Experiment condition: aging at room temperature for 5 hours, formation charging/discharging once @ charging at 0.1 C, 4.25 V/discharging at 0.1 C, 3.0 V

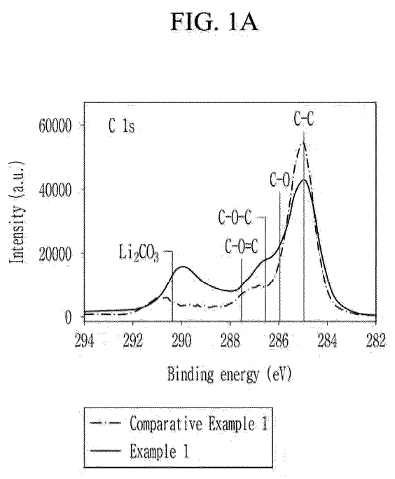

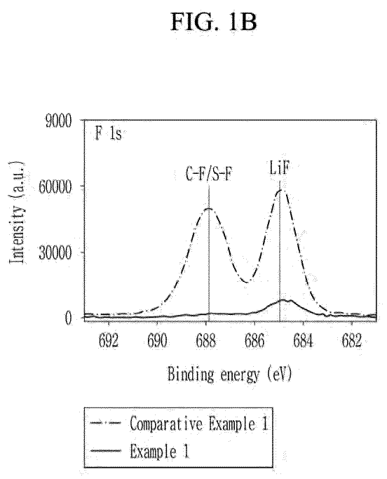

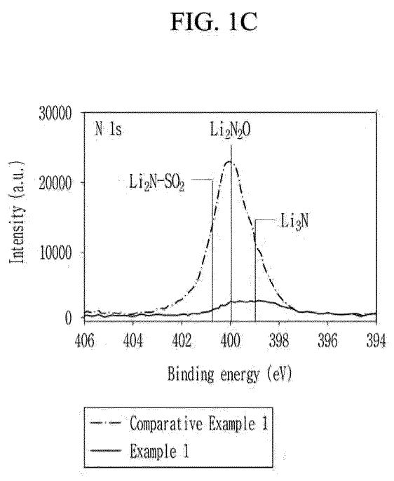

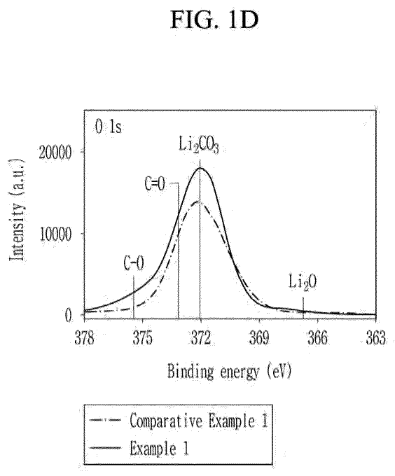

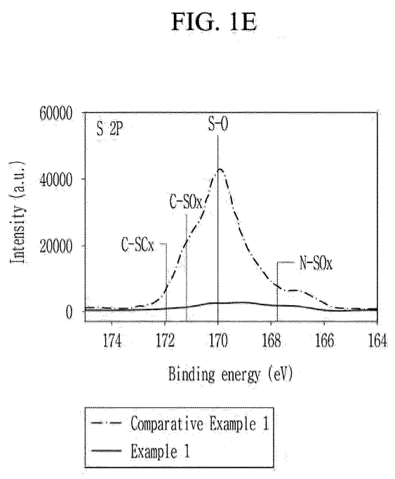

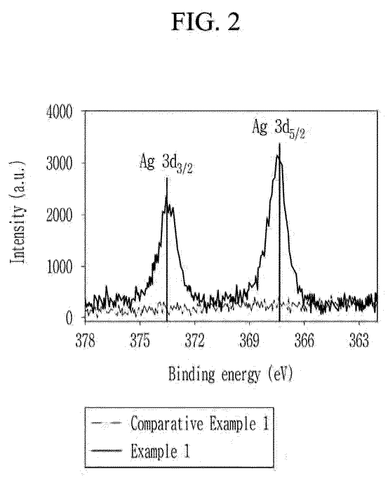

Specifically, the cell was disassembled after the formation cycle of the negative electrode-free battery (Cu|NCM811) manufactured with the electrolyte solutions according to Example 1 and Comparative Example 1, X-Ray Photoelectron Spectroscopy (XPS) analysis of the Cu current collector interface was performed, and the results are shown in FIGS. 1 and 2.

Referring to FIGS. 1A to 1D, a Li₂CO₃-rich SEI layer was formed in Example 1 to which an AgHFB additive was introduced, but referring to FIGS. 1B, 1C, and 1E, it was shown that since LiFSI salt decomposition was effectively suppressed, formation of by-product by FSI-anion decomposition was effectively suppressed. However, in Comparative Example 1 to which the AgHFB additive was not introduced, it was shown that an SEI layer component by FSI-anion decomposition accounted for the majority. As such, when the SEI layer was formed by the FSI-anion decomposition, anions in the primary solvation structure of the electrolyte solution were consumed, and the solvation structure was changed and the electrolyte solution was lower-concentrated, and thus, decomposition of the FSI-anion needs to be suppressed.

Referring to FIG. 2, it was confirmed that an Ag-based coating was formed on the surface of a Cu current collector by the reduction decomposition of AgHFB during the formation cycle.

### Evaluation Example 1-2: Evaluation of Li/NCM811 Negative Electrode-Free Cell Electrode Interface

Cell type: 20 μm Li/W-scope separator (16 pi)/NCM811 positive electrode, 1.5 T spacer, coin type cell 2032

Amount of electrolyte solution injected: 15 μl

Experiment condition: aging at room temperature for 5 hours, formation charging/discharging once @ charging at 0.1 C, 4.25 V/discharging at 0.1 C, 3.0 V

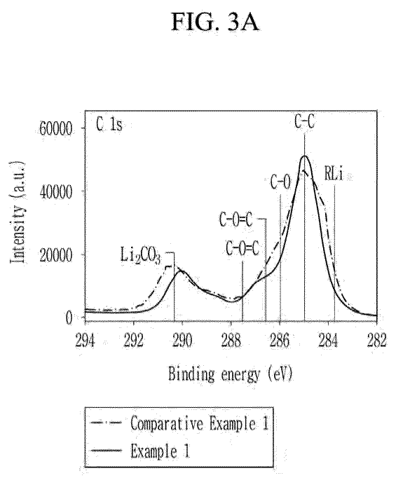

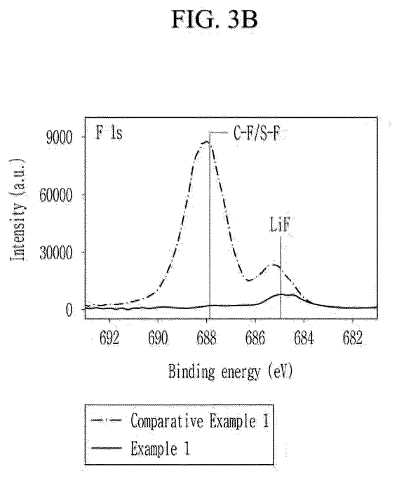

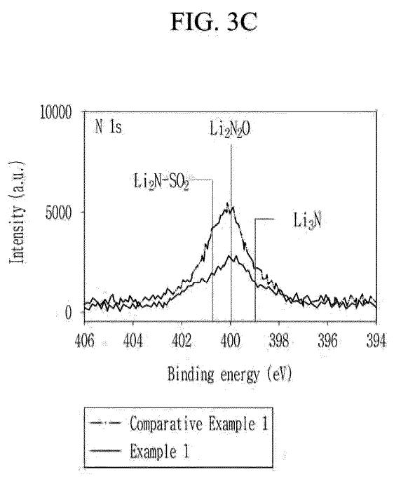

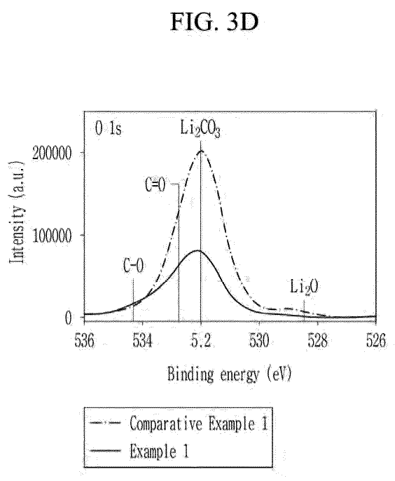

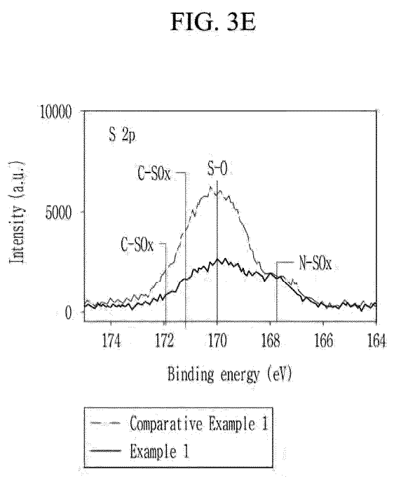

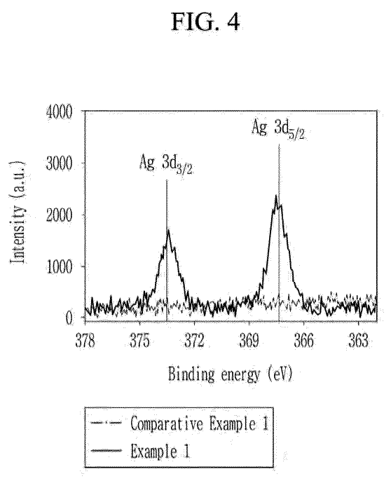

The evaluation was performed by performing X-Ray Photoelectron Spectroscopy (XPS) analysis of a lithium metal surface after formation cycles of the lithium metal battery (Li|NCM811) manufactured with each of the electrolyte solutions according to Comparative Example 1 and Example 1, in order to grasp the Ag-based coating formation on the surface of a lithium metal after formation cycle, like XPS analysis of the Cu current collector interface performed above, and the results are shown in FIGS. 3 and 4.

Referring to FIGS. 3B, 3C, and 3E, when the electrolyte solution of Example 1 was used, LiFSI salt decomposition was effectively suppressed, and thus, the content of S—F/C—F, sulfur, and nitrogen-based coatings which were by-products of FSI⁻ anion decomposition was decreased. Referring to FIGS. 3A and 3D, it was shown that since a volume change of lithium occurring during the cycle was not suppressed, and formation of organic material and Li₂CO₃-based coatings which has high electron conductivity and accelerates a side reaction between the electrolyte solution and the lithium metal was also effectively suppressed, stability of a lithium metal interface was greatly improved.

However, in the electrolyte solution of Comparative Example 1 to which the AgHFB additive was not introduced, since by-products by anion decomposition and an organic material-based coating were formed, a stable SEI layer which may effectively suppress the side reaction between lithium and the electrolyte solution was not formed.

In addition, referring to FIG. 4, it was confirmed that an Ag-based coating by reduction decomposition of AgHFB was formed on the surface of the Cu current collector during the formation cycle.

### Evaluation Example 2: Analysis of Electrodeposited Lithium Image

### Evaluation Example 2-1: Analysis of Electrodeposited Lithium Digital Photo Images

Cell type: 20 μm Li/W-scope separator (19 pi)/Cu, 1.0T spacer, coin type cell 2032

Amount of electrolyte solution injected: 15 μl

Experiment condition: aging at room temperature for 1 hour, formation charge current density (0.2 mA cm⁻²)

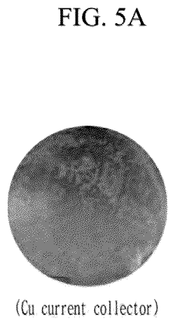

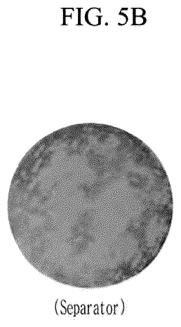

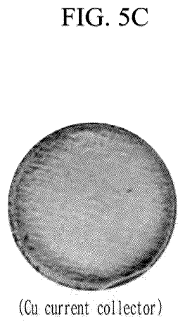

A 20 μm Li/Cu cell was manufactured, and the digital photo images of electrodeposited lithium were taken and are shown in FIGS. 5A to 5C.

Referring to FIGS. 5A and 5B, when the electrolyte solution of Comparative Example 1 was used, lithium electrodeposition on the Cu current collector (FIG. 5A) did not occur well, and the electrodeposited lithium attached to the separator (FIG. 5B) was confirmed.

Since electrodeposition of a lithium ion did not occur well due to the problem unique to the Cu current collector, electrodeposition was difficult, and also, since overvoltage occurred during electrodeposition, an additional side reaction with the electrolyte solution may occur.

### Evaluation Example 2-2: Analysis of Electrodeposited Lithium SEM Images

Cell type: 20 μm Li/W-scope separator (19 pi)/Cu, 1.0 T spacer, coin type cell 2032

Amount of electrolyte solution injected: 15 μl

Experiment condition: aging at room temperature for 1 hour, formation charge current density (0.2 mA cm⁻²)

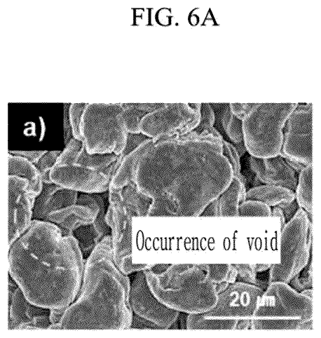

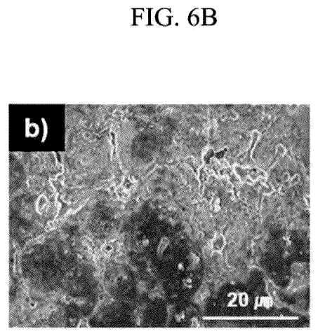

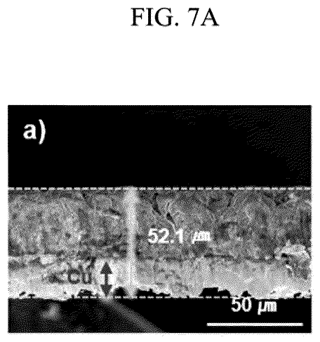

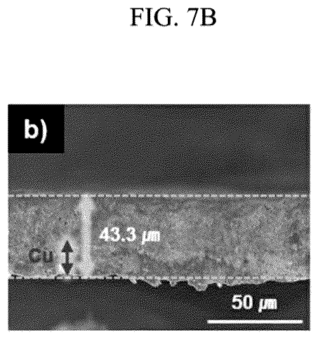

A 20 μm Li/Cu cell was manufactured, scanning electron microscope (SEM) analysis of electrodeposited lithium was performed, and the results are shown in FIGS. 6 and 7.

Referring to FIG. 6A, it was confirmed that when the electrolyte solution of Comparative Example 1 to which the AgHFB additive was not introduced was used, voids occurred on the surface of the electrodeposited lithium. When the voids were present on the surface of lithium as such, the electrolyte solution permeated into the voids to cause a side reaction between lithium and the electrolyte solution.

Referring to FIG. 6B, it was confirmed that when the electrolyte solution of Example 1 to which the AgHFB additive was introduced was used, lithium was evenly electrodeposited without voids on the surface of electrodeposited lithium.

FIGS. 7A and 7B show results of cross-sectional SEM analysis of electrodeposited lithium of batteries using the electrolyte solutions of Example 1 and Comparative Example 1.

At this time, after charging and discharging, SEM analysis of a cross section cut vertically through the cell based on a large surface of a vertical current collector was performed.

FIG. 7A is an electrodeposited lithium cross-sectional SEM image when the electrolyte solution according to Comparative Example 1 was used, and FIG. 7B is an electrodeposited lithium cross-sectional SEM image when the electrolyte solution according to Example 1 was used. Referring to FIGS. 7A and 7B, since the electrodeposited lithium of Comparative Example 1 having voids on the surface caused a side reaction with the electrolyte solution, a thickness of the electrodeposited lithium layer was about 52.1 μm.

However, when electrolyte solution of Example 1 to which the AgHFB additive was introduced was used, void formation was suppressed, and thus, it was confirmed that a thinner electrodeposited lithium (43.3 μm) was formed as compared with the case of using the electrolyte solution of Comparative Example 1 due to suppression of a side reaction between the electrolyte solution and a lithium metal.

It was confirmed that the morphology difference in electrodeposited lithium as such had a significant influence on the thickness of the electrodeposited lithium.

Therefore, it was shown that the Ag-based coating formed by the AgHFB additive lowers lithium electrodeposition overvoltage to assist lithium to be uniformly electrodeposited without forming voids, and also suppresses a side reaction between electrodeposited lithium and the electrolyte solution and is effective for thin lithium electrodeposition.

### Evaluation Example 3: Cell Initial Efficiency

Cell type: 20 μm Li/W-scope separator (19 pi)/Cu, 1.0 T spacer, coin type cell 2032

Amount of electrolyte solution injected: 15 μl

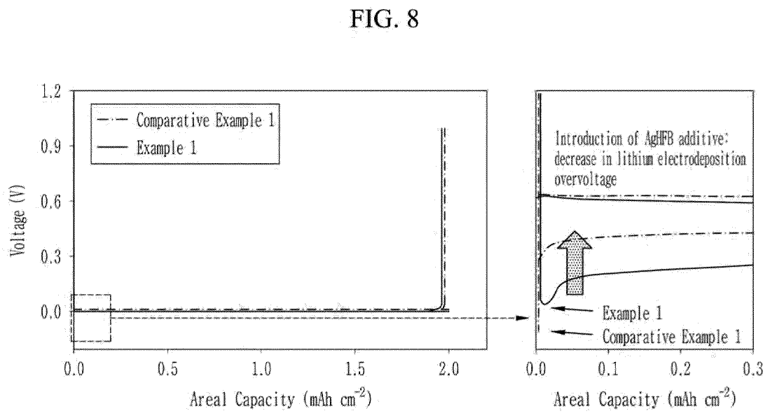

Experiment condition: aging at room temperature for 1 hour, formation charge/discharge current density (0.2 mAcm⁻²) 20 μm Li/Cu cells were manufactured using the electrolyte solutions according to Example 1 and Comparative Example 1, cell initial efficiency analysis was performed in order to evaluate reversibility of lithium, and the results are shown in FIG. 8 and the following Table 2.

Referring to FIG. 8 and Table 2, when the electrolyte solution according to Example 1 to which the AgHFB additive was introduced was used, an Ag-based coating was formed on the surface of the Cu current collector and a lithium metal, and thus, the initial reversible efficiency was shown to be low as compared with the case of using the electrolyte solution according to Comparative Example 1.

However, upon comparison of electrodeposition overvoltage, it was confirmed that when the electrolyte solution according to Example 1 to which the AgHFB additive was introduced was used, electrodeposition overvoltage was greatly decreased.

It was confirmed that when the electrolyte solution according to Comparative Example 1 to which the additive was not introduced was used, electrodeposition overvoltage of 34.6 mV was shown, but when electrolyte solution of Example 1 to which the AgHFB additive was introduced was used, electrodeposition overvoltage was greatly decreased due to the overvoltage of 26 mV during lithium electrodeposition.

Thus, it was shown therefrom that when the AgHFB additive was introduced, an Ag-based coating was formed on the surface of the Cu current collector and the lithium metal, and by the Ag-based coating formed at this time, though initial lithium reversibility was low, an effect of greatly decreasing lithium electrodeposition overvoltage was shown.

TABLE 2

| | Comparative | |
|---|---|---|
| | Example 1 | Example 1 |
| ICE (%) | 98.7 | 98.3 |
| Electrodeposition | 34.6 | 26 |
| overvoltage (Mv) | | |

### Evaluation Example 4: Evaluation of Battery Life

(Evaluation Example 4-1: evaluation of Cu/NCM811 negative electrode-free cell life)

Cell type: Cu/W-scope separator (16 pi)/NCM811 positive electrode, 1.5 T spacer, coin type cell 2032

Amount of electrolyte solution injected: 15 μl

Experiment condition: aging at room temperature for 5 hours, formation charging/discharging 2 times @ 0.1 C, 4.25 V/0.1 C, 3.0 V, cycle @ ⅓ C, 4.25 V/CV: 4.25 V, 0.05 C/⅓ C, 3.0 V/rest 30 min), 1 C =188.24 mAhg⁻¹

$$Coulomb efficiency ( \% ) : ( cycle discharge \text{capacity/cycle} charge capacity ) \times 100$$

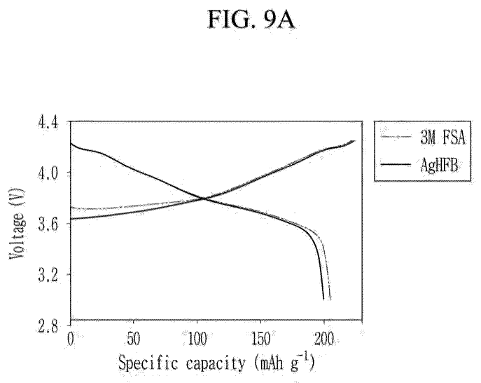

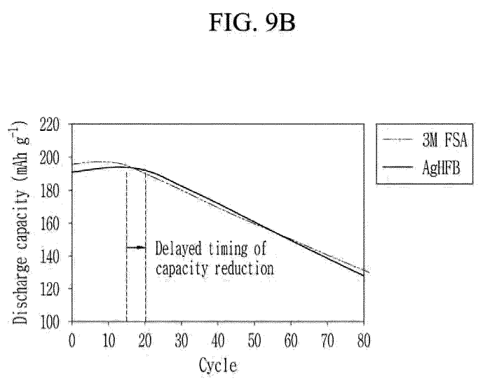

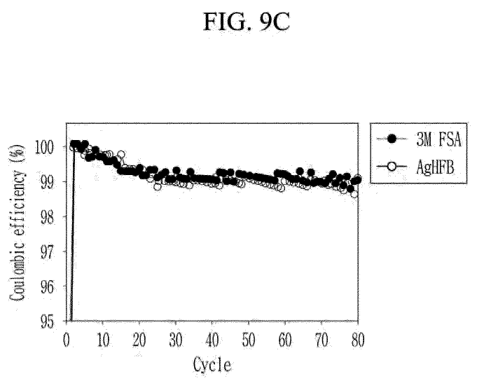

Evaluation of Cu/NCM811 negative electrode-free battery life was performed, and the results are shown in FIG. 9. FIG. 9A is a formation charge/discharge graph, FIG. 9B is a cycle discharging capacity graph, and FIG. 9C is a coulomb efficiency graph.

Referring to FIG. 9A, it was confirmed that when the electrolyte solution according to Example 1 to which the AgHFB additive was introduced was used, the AgHFB additive which received electrons from the Cu current collector during a charging process was reduced and decomposed to form the Ag-based coating, and thus, initial electrodeposition overvoltage was greatly decreased.

Referring to FIGS. 9B and 9C, it was shown that there was no big difference in the electrolyte solution lifespan between when the electrolyte solution according to Comparative Example 1 to which the AgHFB additive was not introduced was used and when the electrolyte solution according to Example 1 to which the AgHFB additive was introduced was used, but when the electrolyte solution according to Example 1 was used, the interface was greatly stabilized by the Ag-based SEI layer formation on the surface of the Cu current collector, and thus, the timing when a discharge capacity decreased was delayed. It was confirmed that when the electrolyte solution of Comparative Example 1 was used, a continuous discharge capacity decrease occurred after about 15 cycles, but when the electrolyte solution of Example 1 was used, the phenomenon occurred after about 20 cycles by SEI layer stabilization.

### Evaluation Example 4-2: Evaluation of Li/NCM811 Full Cell Life

Cell type: 20 μm Li/W-scope separator (16 pi)/NCM811 positive electrode, 1.5 T spacer, coin type cell 2032

Amount of electrolyte solution injected: 15 μl

Amount of electrolyte solution injected: 15 μl

Experiment condition: aging at room temperature for 5 hours, formation charging/discharging 2 times @ 0.1 C, 4.25 V/0.1 C, 3.0 V, cycle @ ⅓ C, 4.25 V/CV: 4.25 V, 0.05 C/⅓ C, 3.0 V/rest 30 min), 1 C =188.24 mAhg⁻¹

$$Coulomb efficiency ( \% ) : ( cycle discharge \text{capacity/cycle} charge capacity ) \times 100$$

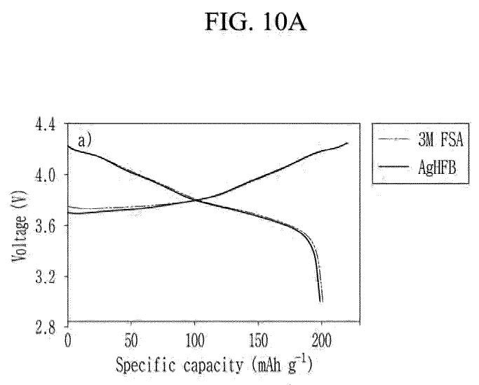

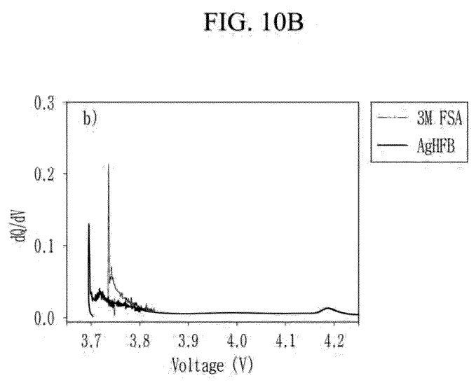

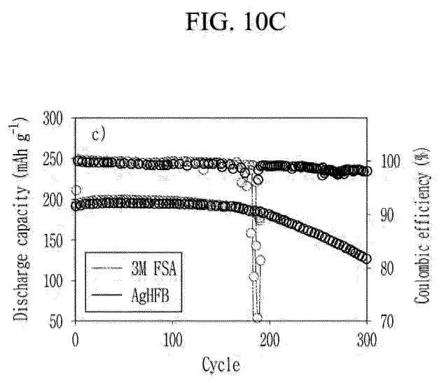

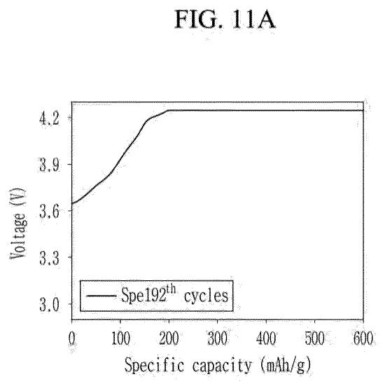

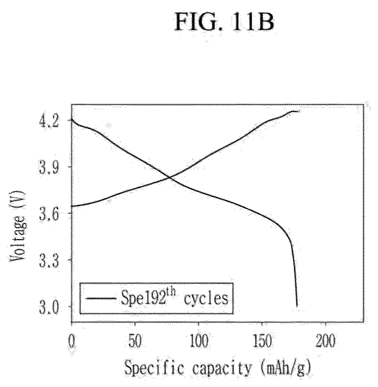

Evaluation of Li/NCM811 battery life was performed, and the results are shown in FIGS. 10A to FIG. 10C, 11A, and 11B, and Table 3. FIG. 10A is a formation charge/discharge graph, FIG. 10B is a discharge dQ/dV graph, and FIG. 10C is a coulomb efficiency graph.

Referring to FIG. 10A, it was confirmed that when the electrolyte solution according to Example 1 to which the AgHFB additive was introduced was used, an Ag-based SEI layer was formed on a lithium interface during the initial formation cycle, and thus, overvoltage was greatly decreased.

Referring to FIG. 10B, it was confirmed that when the electrolyte solution according to Comparative Example 1 to which the AgHFB additive was not introduced was used, a voltage band which was delithiated from the positive electrode by initial overvoltage was pushed back.

FIG. 11A is a charge and discharge graph at 192^{nd} cycle of the Li/NCM811 battery using the electrolyte solution of Comparative Example 1. FIG. 11B is a charge and discharge graph at 192^{nd} cycle of the Li/NCM811 battery using the electrolyte solution of Example 1.

Referring to FIGS. 11A and 11B, when the electrolyte solution of Comparative Example 1 was used, overcharge was applied at 192^{nd} cycle and the lifespan did not proceed any more, but when the electrolyte solution of Example 1 was used, stable lifespan proceeded without overcharge in the case of forming the Ag-based SEI layer.

Referring to Table 3, when the electrolyte solution of Comparative Example 1 was used, the lifespan was stopped at 192^{nd} cycle, but when the electrolyte solution of Example 1 was used, the lithium metal battery was operated until 290^{th} cycles, based on a retention of 70%. When the electrolyte solution of Example 1 was used, the coulomb efficiency value was also confirmed to be excellent as compared with the case of using the electrolyte solution of Comparative Example 1.

Therefore, it was shown that the Ag-based coating formed by the AgHFB additive decreased the lithium electrodeposition overvoltage and also suppressed a side reaction between the electrolyte solution and the lithium metal, and thus, had an effect of improving reversibility of a lithium ion. Furthermore, it was confirmed that the side reaction between the lithium metal and the electrolyte solution occurring during the cycles was effectively suppressed, and thus, the cycles and column efficiency of the Li/NCM811 full cell were improved.

TABLE 3

| | Comparative Example 1 | Example 1 |
|---|---|---|
| Charge capacity (mAh/g) | 220.9 | 220.0 |
| Discharge capacity (mAh/g) | 200.9 | 198.7 |
| ICE (%) | 90.9 | 90.3 |
| Cycle (retention 70%) | 190 | 290 |
| Reversible efficiency (%) | 98.5 | 99.1 |

### Evaluation Example 4-3: Evaluation of Cu/NCM811 Negative Electrode-Free Cell Life Depending on AgHFB Content

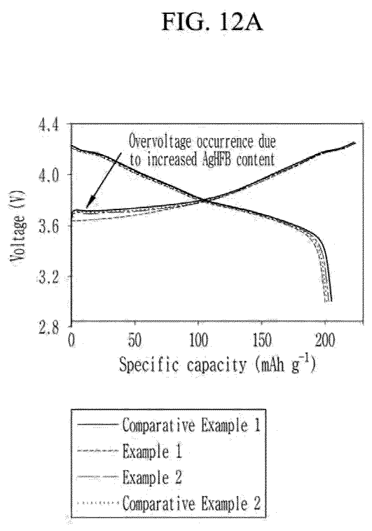

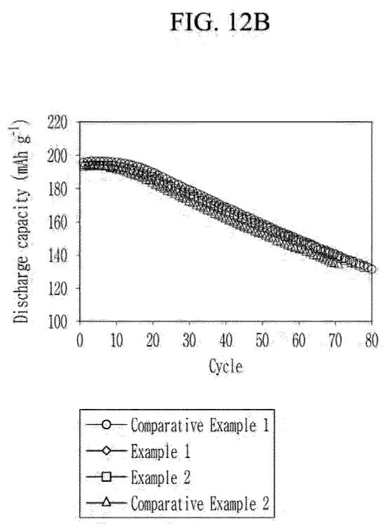

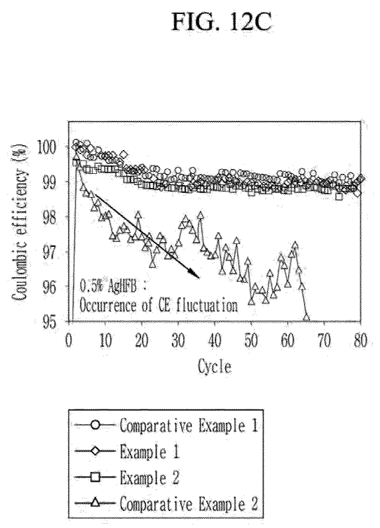

Evaluation of Cu/NCM811 negative electrode-free battery life was performed in the same manner as in Evaluation Example 4-1, except that each of the electrolyte solutions according to Example 2 and Comparative Example 2 was used as the electrolyte solution, and the results are shown in FIGS. 12A to 12C and Table 4.

Referring to 12A to 12C, it was confirmed that when the electrolyte solution according to Comparative Example 2 was used, rapid CE fluctuation occurred and stable cycle operation did not occur. In addition, it was shown that overvoltage occurred during an initial charging process depending on a content increase at the content of the AgHFB additive of 0.1 wt % or more.

TABLE 4

| | Compar- | | | Compar- |
|---|---|---|---|---|
| | ative | Example | Example | ative |
| | Example 1 | 1 | 2 | Example 2 |
| Charge capacity | 223.8 | 221.2 | 223.2 | 222.9 |
| (mAh/g) | | | | |
| Discharge capacity | 204.9 | 200.0 | 202.9 | 201.1 |
| (mAh/g) | | | | |
| ICE (%) | 91.6 | 90.3 | 90.9 | 90.2 |
| Cycle (retention 70%) | 75 | 74 | 76 | 69 |
| Reversible efficiency | 99.2 | 99.1 | 98.8 | 96.9 |
| (%) | | | | |

Referring to Table 4, it was confirmed that in Comparative Example 2, the lithium metal battery was operated until 69 cycles based on 70% retention.

Hereinabove, the preferred example embodiments of the present disclosure have been described, but the present disclosure is not limited thereto, and may be variously modified within the scope of the claims, the detailed description of the disclosure, and the attached drawing, which also belongs to the scope of the present disclosure, of course.

Accordingly, the substantial right scope of the present disclosure is defined by the appended claims and the equivalents thereto.

What is claimed is:

1. An electrolyte solution for a lithium secondary battery comprising:
a lithium salt;
an organic solvent; and
a silver (Ag) compound additive,
wherein the silver (Ag) compound additive comprises one or more selected from AgHFB, AgPFP, or silver trifluoroacetate.

2. The electrolyte solution for a lithium secondary battery of claim 1, wherein the electrolyte solution comprises about 0.05 wt % to 0.2 wt % of the silver (Ag) compound additive based on the total weight of the electrolyte solution.

3. The electrolyte solution for a lithium secondary battery of claim 1, wherein the electrolyte solution comprises about 0.01 wt % to 0.09 wt % of the silver (Ag) compound additive based on the total weight of the electrolyte solution.

4. The electrolyte solution for a lithium secondary battery of claim 1, wherein the nonaqueous organic solvent comprises fluorosulfonamide (FSA).

5. The electrolyte solution for a lithium secondary battery of claim 1, wherein the lithium salt comprises one or more selected from LiFSI, LiPF₆, LiClO₄, LiBF₄, LiTFSI, LiSO₃CF₃, LiBOB, LiFOB, LiDFBP, LiTFOP, LiPO₂F₂, LiCl, LiBr, LiI, LiB 10Cl10, LiCF₃SO₃, LiCF₃CO₂, LiAsF₆, LiSbF₆, LiAlCl₄, CH₃SO₃Li, CF₃SO₃Li, LiSCN, or LiC(CF₃SO₂)₃.

6. The electrolyte solution for a lithium secondary battery of claim 1, wherein the lithium salt has a molar concentration of about 2.5 to 3.5 M.

7. A lithium secondary battery comprising:
a positive electrode;
a negative electrode current collector opposite to the positive electrode;
a separator interposed between the positive electrode and the negative electrode current collector; and
the electrolyte solution for a lithium secondary battery of claim 1.

8. The lithium secondary battery of claim 7, wherein the negative electrode current collector comprises a lithium metal layer formed thereon, and wherein the lithium metal layer is formed by formation charging and discharging of the lithium secondary battery.

9. The lithium secondary battery of claim 8, wherein the lithium secondary battery has a formation charge and discharge current density of about 0.2 mA·cm−2.

10. The lithium secondary battery of claim 8, wherein the lithium metal layer is formed to a thickness of about 40 to 45 μm.

11. The lithium secondary battery of claim 8, wherein the lithium metal layer has a surface pore average diameter of less than about 1 μm.

12. The lithium secondary battery of claim 8, further comprising:
an Ag-based intermediate layer disposed between the negative electrode current collector and the lithium metal layer.

13. The lithium secondary battery of claim 7, wherein the positive electrode comprises a positive electrode active material layer containing a lithium-nickel-manganese-cobalt-based metal oxide.

14. An electrolyte solution for a lithium secondary battery, comprising:
a lithium salt;
an organic solvent comprising at least 50% by volume of fluorosulfonamide (FSA); and
a silver (Ag) compound additive,
wherein the silver (Ag) compound additive comprises one or more selected from AgHFB, AgPFP, or silver trifluoroacetate, and is present in an amount of about 0.05 wt % to 0.1 wt % based on the total weight of the electrolyte solution, to promote the formation of a stable SEI layer and reduce lithium deposition overvoltage.

15. The electrolyte solution for a lithium secondary battery of claim 14, wherein the lithium salt comprises LiFSI, and the concentration of the lithium salt is specifically between about 2.9 M and 3.1 M to optimize ionic conductivity and electrochemical performance.

16. The electrolyte solution for a lithium secondary battery of claim 14, wherein the silver (Ag) compound additive forms an Ag-based coating on the surface of the negative electrode current collector during the initial charging process, improving the reversibility of lithium ions and enhancing surface stabilization.

17. The electrolyte solution for a lithium secondary battery of claim 14, further comprising a secondary additive selected from calcium hydride (CaH2) or magnesium fluoride (MgF₂), in an amount of about 0.5 wt % to 2.0 wt %, to further suppress lithium dendrite growth and enhance electrolyte stability.

18. The electrolyte solution for a lithium secondary battery of claim 14, wherein the nonaqueous organic solvent is selected to maximize the solubility of the silver (Ag) compound additive, facilitating uniform SEI layer formation.

19. The electrolyte solution for a lithium secondary battery of claim 14, wherein the electrolyte solution comprises about 0.1 wt % to 0.2 wt % of the silver (Ag) compound additive.

20. A lithium secondary battery comprising the electrolyte solution of claim 14, a positive electrode, a negative electrode current collector, and a separator, wherein the negative electrode current collector is configured to form a lithium metal layer with a thickness of 40 to 45 μm during the initial charging process, and the lithium metal layer has a surface pore average diameter of less than 1 μm.
